(19) United States
(12) Patent Application Publication
(10) Pub. No.: US 2003/0001543 A1
(43) Pub. Date: Jan. 2, 2003

(54) Device charger

(76) Inventor: Kenneth D. Eisenbraun, Bloomfield Village, MI (US)

Correspondence Address: Avery N. Goldstein, Ph.D., Gifford, Krass, Groh, Sprinkle,, Anderson & Citkowski, P.C., 280 N. Old Woodward Avenue, Suite 400, Birmingham, MI, 48009-5394, US

(21) Appl. No.: 09/893,933

(22) Filed: Jun. 28, 2001

(51) Int. Cl. H02J 7/04; H02J 7/16

(52) U.S. Cl. 320/162

(57) ABSTRACT

A portable electronic device charger has circuitry to protect a vehicle power source from excessive drain associated with portable electronic device charging. An air purification system is provided to lessen electrostatic particulate accumulation on the charger and portable electronic device during charging. A flexible portion within the charger is optionally provided to accommodate various vehicle geometries in the region about a cigarette lighter power source.

### FIELD OF THE INVENTION

The present invention relates generally to a portable device charger, and more particularly to a charger having circuitry adapted to protect a vehicle battery power source from excessive drain.

### BACKGROUND OF THE INVENTION

Portable devices such as cell phones and handheld computers are often charged by a user in transit to a remote location. The charging of a portable electronic device in transit affords the advantage of assuring that the device is as fully charged as possible upon arrival at a remote location. It is commonplace for a charger to remain in permanent electrical contact with the cigarette lighter of a vehicle electrical system. Conventional chargers often include an indicator light emitting diode (LED) to alert a vehicle operator that the charger is in electrical contact with the vehicle electrical system. The constant illumination of the indicator LED often raises concerns with a vehicle operator that the charger is unnecessarily draining the vehicle battery while the vehicle is not running. Thus, it is common for a vehicle operator to disengage the charger from the vehicle cigarette lighter receptacle to prevent an unnecessary vehicle battery drain and extinguish the indicator LED. The additional wear on the charger electrical contacts associated with disengaging the charger from the cigarette lighter shortens the service lifetime of the charger.

A further concern in utilizing a vehicle electrical system as a power source to charge a portable electronic device focuses on concerns that drawing current from a battery that has begun to fail or charging from a vehicle electrical system from a vehicle that has not been run over a prolonged period of time so as to recharge the vehicle battery. These concerns are amplified in climates where the electrical system of the vehicle is particularly burdened in starting the vehicle. Thus, there exists a need for a charger that senses the condition of a battery power source and disables portable electronic device charging when the sensed power source has a measured property below a preselected threshold.

### SUMMARY OF THE INVENTION

A portable electronic charger device includes a charger housing having a coupler portion adapted to engage a cigarette lighter source of a vehicle and also having a main body portion. An electrical contact extends from the coupler portion and is adapted to electrically engage the cigarette lighter power source of a vehicle. An electrical circuit intermediate between the cigarette lighter power source and a portable electronic device is adapted to sense the input voltage of the vehicle power source and prevent current flow to the portable electronic device when the input voltage is below a preselected threshold. Typically, the preselected threshold is between 12 and 13.6 volts. In another embodiment, an LED indicating electrical contact between an inventive charger and a cigarette lighter power source is deactivated with a manual switch to prevent power drain on a parked vehicle. An air purification system is optionally coupled to an inventive charger to prevent electrostatic dust accumulation on charger and device components.

An inventive charger in another embodiment includes a coupler portion adapted to electrically engage the cigarette lighter power source of a vehicle through electrical contacts, a body portion and a flexible or jointed portion therebetween. The flexible portion accommodating a variety of vehicle geometries in the area surrounding a cigarette lighter power source. A connector complementary to a portable electronic device is provided to couple a given device for charging purposes.

### BRIEF DESCRIPTION OF THE DRAWINGS

FIG. 1 is a partial cutaway perspective view of an embodiment of an inventive charger;

FIGS. 2A-D are (A) plan, (B) side, (C) perspective and (D) frontal views of a variant of the embodiment depicted in FIG. 1 having a flexible portion defined by two orthogonal hinge pivots;

FIG. 3 is a partial cutaway perspective view of another embodiment of an inventive charger having a docking fixture for receiving a portable electronic device;

FIG. 4 is a partial cutaway perspective view of still another embodiment of an inventive charger incorporating an air purification system; and

FIG. 5 is a schematic circuit diagram of an inventive portable electronic device charger.

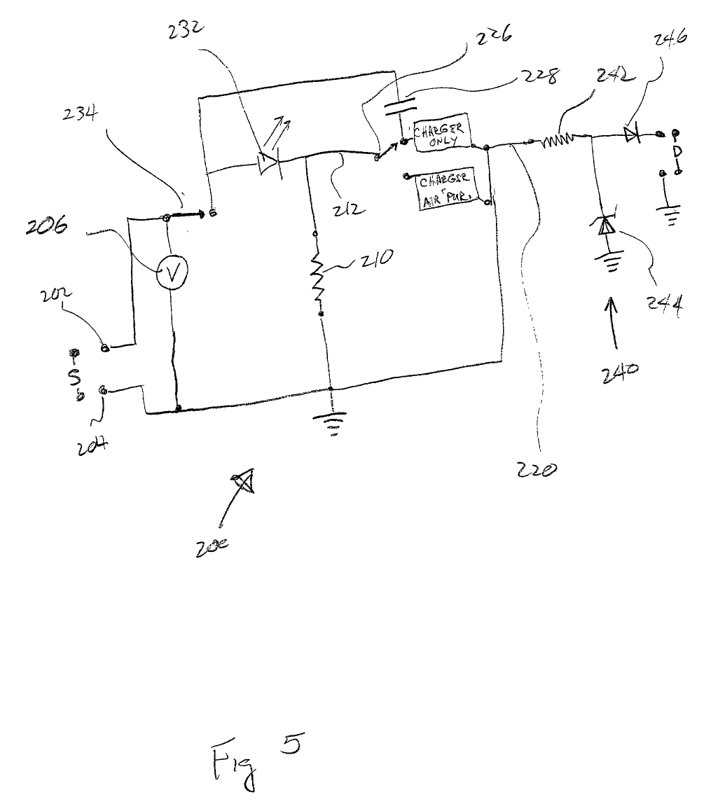

### DETAILED DESCRIPTION OF THE PREFERRED EMBODIMENTS

The present invention has utility as a portable electronic device charger, particularly well suited for operation from a vehicle power system.

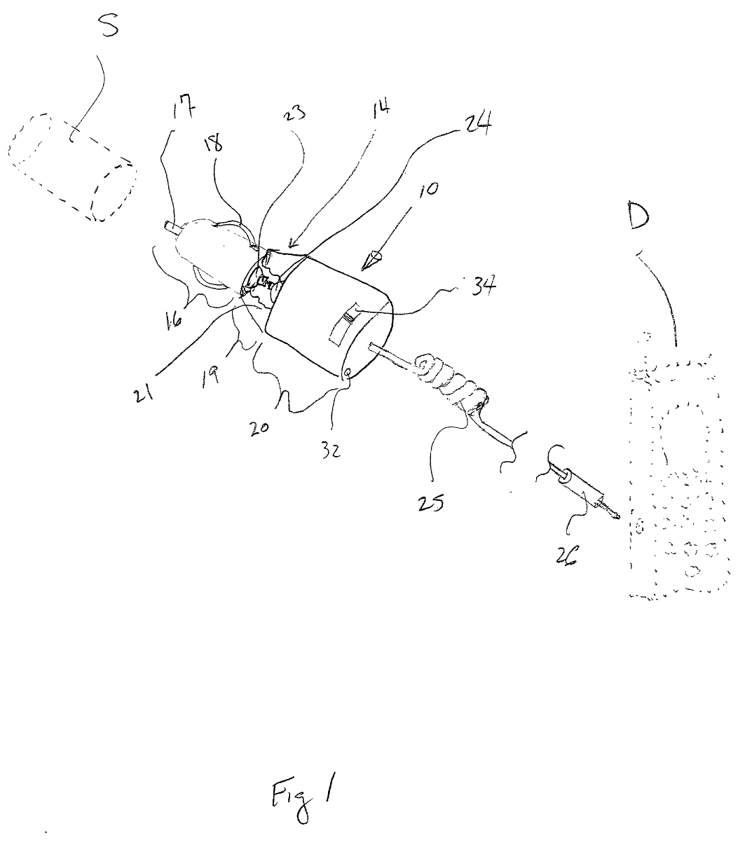

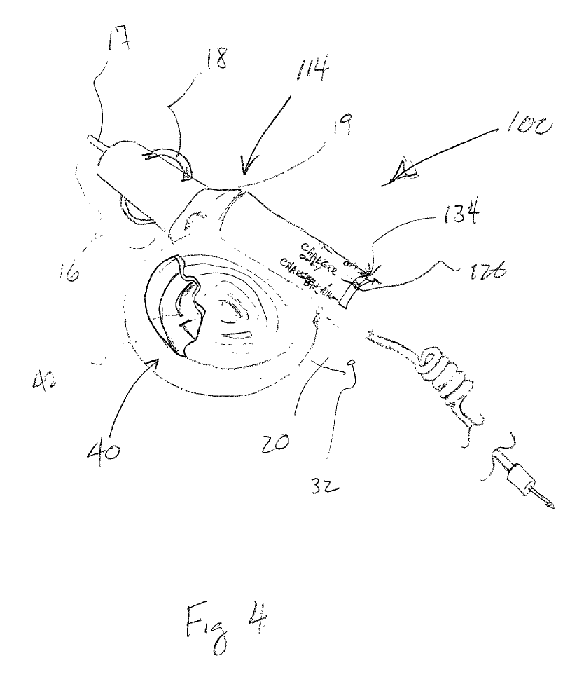

Referring now to FIG. 1, an inventive charger is shown generally at 10. The portable charger 10 is adapted to plug into a direct current cigarette lighter socket of a vehicle power system. The charger 10 includes a charger housing 14 having a coupler portion 16 adapted to be inserted into the vehicle direct current cigarette lighter socket. The coupler portion 16 has an electrical contact 18 extending therefrom and adapted to engage a cigarette lighter socket sidewall in order to electrically ground the inventive charger 10. The coupler portion 16 also terminates in an electrical contact 17 adapted to engage the voltage contact of the vehicle direct current cigarette lighter S. The charger housing 14 also includes a main body portion 20. Preferably, a flexible portion 19 interconnects coupler portion 16 and main body portion 20. The flexible portion 19 includes a ball joint fitting 23 and more preferably a second ball joint fitting 24 arranged to accommodate various vehicle geometries in the region around the lighter socket S. A covering 21 prevents entrainment of debris within a ball joint 23 or 24 of the flexible portion 19. Alternatively, in the present invention a reticulated elastomeric tube member (not shown) is operative as a flexible portion 19. The main body portion 20 includes electrical circuitry (FIG. 4) that upon the charger 10 engaging the cigarette lighter socket S, the circuitry senses the direct current input voltage from the vehicle power system and prevents current flow to a coupled device D when the input voltage is below a preselected threshold. In a typical vehicle power supply, the charger activation voltage threshold is 12.6 volts. Thus, the inventive charger having a 12.6 volt activation threshold will not allow current flow to an electrically coupled portable electronic device D when the vehicle is not running or the vehicle battery is beginning to fail through, for example, a shorted battery cell or dislodgement of a battery ground. It will be appreciated that other vehicle voltage thresholds are operative herein based upon the characteristics of the vehicle power system. In the embodiment of the present invention shown in FIG. 1, the charger 10 is electrically coupled to a portable electronic device shown in phantom at D by way of a coiled, externally insulated cord 25 terminating in a device connector 26 complementary with that of the device D.

In a preferred embodiment of the present invention, a light emitting diode (LED) 32 is observable on the housing 14 of the charger 10 while engaging a cigarette lighter socket S. The LED 32 activating upon the charger 10 being in electrical contact with the cigarette lighter S. A manual switch 34 is provided on the main body portion 20 of the housing 14 in order to selectively deactivate the LED 32 thereby allaying concerns that the inventive charger 10 is drawing current from cigarette lighter S at inopportune or undesirable times such as when the vehicle is not running for prolonged periods of time. It is appreciated that an LED manual deactivation switch 34 is operative independently of voltage sensing circuitry.

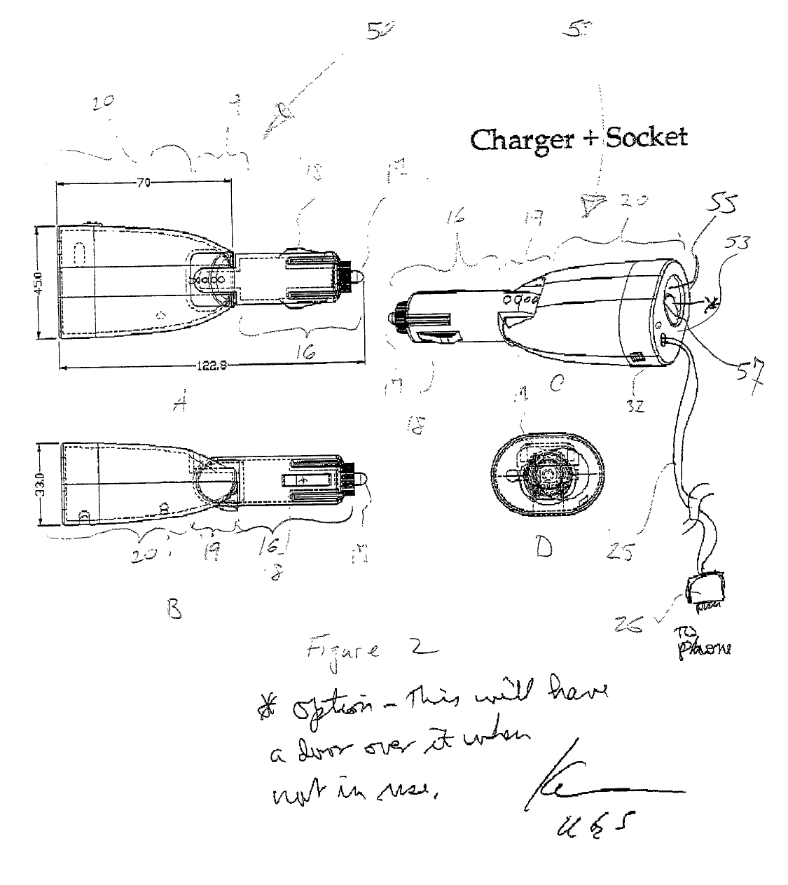

Referring now to FIG. 2, where like numbers correspond to components described with respect to FIG. 1, an inventive charger is shown generally at 50. The flexible portion 19 is defined by a pair of hinged pivots offset at approximately a right angle to afford charger orientation adapted to various vehicle geometries in the region about the lighter socket S. The rearward face 53 of the charger 50 optionally has a charger socket 55 similar to that of the vehicle socket S. The socket 55 is provided to allow coupling of another electrical device or the heating element provided with the vehicle that absent the inventive charger inserts into the lighter socket S. An optional spring loaded cover 57 prevents debris accumulation within the socket 55.

Alternatively, the embodiment of the invention depicted in FIG. 2 couples to the device D by way of a docking fixture 30 having a device complementary connector 26 extending into the cavity 31 defined by the docking fixture 30 adapted to receive the device D. Thus, the device connector 26 electrically engages the device D upon the device being seated within the docking fixture 30. In this embodiment, the flexible portion 19 is contemplated to maintain an orientation upon being fixed and while the inventive charger is docking a device D. Optionally, an LED 32 is provided to indicate connectivity to a cigarette lighter socket S.

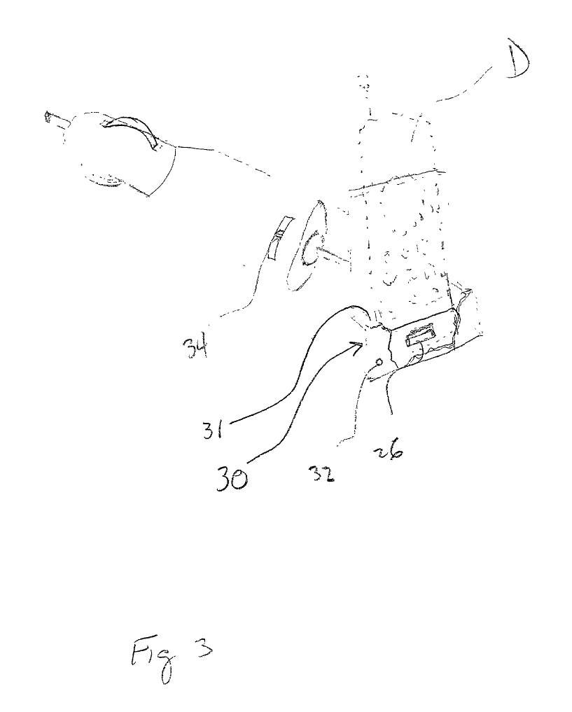

As shown in FIG. 3, a charger 100 according to the present invention includes within the housing 114 an air purifier 40 with like number elements being the same as those detailed with respect to FIG. 1. The air purifier 40 having an ionization source. An air purifier operates with a charger to lessen the accumulation of dust and other particulate on device and charger components associated with static charging associated with the device charging process. Preferably, the air purification system 40 includes an ionization source 42 for electrostatic decomposition of airborne compounds and particulate that foul the air within the vehicle passenger compartment.

In the embodiment of the present invention having minimum voltage sensing circuitry and a manual on-off switch 134, as well as an air purification system 40, the switch is preferably a three position slide switch 126. The three slide positions include “off” having an inactive device charging and air purification system function denoted by an inactive LED if an LED 32 is present. A second switch position is “charge only” activating only the device charging aspect and an inactive air purification system that is indicated by a flashing LED if an LED is present. The third switch position is “all on” denoting current flow to both the charger and the air purification system. A third switch position is indicated by a solid LED, if an LED 32 is present. An “all on” position when simultaneous charging and air purifying is desired, as well as should only air purification be desired then removing the device D from electrical contact with the inventive charger thus leaving the charging circuit open.

Referring now to FIG. 4, the basic charging circuit is shown at 200. The circuit input 202 of circuit 200 is established by a charger terminal contact such as 17 of FIG. 1 being in electrical contact with a positive voltage supplied by the direct current cigarette lighter. The ground input 204 results from an electrical contact such as 18 in FIG. 1 being in electrical communication with the side of the cigarette lighter power source S. The direct current voltage applied across terminals 202 and 204 is detailed above in the typical vehicle ranges from about 12 to 13.6 volts. A voltage sensing subcircuit 206 measures the voltage across terminals 202 and 204 and only if the voltage across the source S is greater than a predetermined threshold of approximately 12.6 volts is the remainder of the circuit 200 activated. Provided the voltage of the source S is greater than the minimum voltage threshold, then a manual on-off switch 234, shown in an active position, allows an indicator LED 232 to be illuminated indicating that the charger circuit 200 is active and a current limited by a resistor 210 is applied to the portable electronic device D rechargeable cells. Line 212 thus applies current to the selector switch 226 that when switched to the “all on” position activates the charger and air purification functions. When the switch 226 is moved to the “charger on” position only, current flows to the charger subcircuit and a feedback capacitor 228 modulates the LED 232 such that it illuminates only intermittently.

Voltage on line 220 of the charger subcircuit 240 includes a current limiting resistor 242 shunted by a Zener diode 244 and connected to an isolated diode 246. Thus, the charger subcircuit 240 inputs a preselected voltage such that a portable electronic device D coupled thereto receives a device appropriate charging voltage.

It is appreciated that various alterations and modifications to the present invention which has been described in terms of the presently preferred embodiments will become apparent to those skilled in the art. Accordingly, it is intended that the appended claims be interpreted as covering all alterations and modifications as defined by the scope of the appended claims.

1. A portable electronic device charger comprising:
a charger housing having a coupler portion adapted to engage a cigarette lighter source and having a body portion;
an electrical contact extending from the coupler portion and adapted to electrically engage said cigarette lighter power source; and
an electrical circuit intermediate between said power source and a portable electronic device, said circuit adapted to sense the input voltage of said source and prevent current flow to said portable electronic device when the input voltage is below a preselected threshold.

2. The charger of claim 1 further comprising an electrical subcircuit for metering current to said device at a preselected voltage.

3. The charger of claim 1 wherein the preselected voltage threshold is between 12 and 13.6 volts.

4. The charger of claim 1 further comprising an LED indicating said electrical contacts are in electrical engagement with said cigarette lighter power source.

5. The charger of claim 1 further comprising a manual switch in electrical contact with said electrical circuit, said switch in an off position adapted to prevent current flow to said device.

6. The charger of claim 4 further comprising a manual switch, said switch in an off position selectively deactivating said LED.

7. The charger of claim 1 further comprising an air purification system within said charger housing.

8. The charger of claim 1 wherein said charger housing is adapted for docking said device.

9. The charger of claim 1 further comprising an insulated electrical cable extending from said charger housing for coupling said device.

10. A portable electronic device charger comprising:
a charger housing having a coupler portion adapted to engage a cigarette lighter power source and having a body portion;
electrical contacts extending from said coupler portion and adapted to engage said cigarette lighter power source;
an LED within said charger housing indicating said electrical contacts are in electrical engagement with said cigarette lighter power source; and
a manual switch to selectively deactivate said LED.

11. The charger of claim 10 further comprising an air purification system.

12. The charger of claim 11 further comprising a control for selectively energizing both the charger and said air purification system, said controller in another position only activating one of said charger air purification system functions.

13. The charger of claim 11 wherein said air purification system comprises an ionization source.

14. A portable electronic device charger comprising:
a charger housing having a coupler portion, a body portion and a flexible portion therebetween;
an electrical contact extending from the coupler portion and adapted to electrically engage said cigarette lighter power source; and
a connector complementary to a portable electronic device in electrical contact between said power source and said device.

15. The charger of claim 14 further comprising an electrical circuit intermediate between said power source and a portable electronic device, said circuit adapted to sense the input voltage of said source and prevent current flow to said portable electronic device when the input voltage is below a preselected threshold.

16. The charger of claim 14 further comprising an electrical subcircuit for metering current to said device at a preselected voltage.

17. The charger of claim 14 further comprising an insulated electrical cable extending from said charger housing for coupling said device.

18. The charger of claim 14 wherein the flexible portion comprises a first ball joint fitting.

19. The charger of claim 18 further comprising a second ball joint fitting disjointed from the first ball joint fitting.

20. The charger of claim 18 further comprising a covering over the first ball joint fitting.

21. The charger of claim 14 wherein the flexible portion comprises a reticulated elastomeric tube member.

22. A process for charging a portable electronic device comprising the steps of:
electrically coupling a charger to a vehicle power supply;
coupling said charger to said device;
sensing a power supply voltage is greater than a preselected threshold; and
metering current from said power supply to said device by way of said charger.

23. The process of claim 22 further comprising the step of: activating an indicator LED upon said charger coupling said power supply.

24. The process of claim 23 wherein said indicator LED is manually activated.
